(19) United States
(12) Patent Application Publication
(10) Pub. No.: US 2026/0268257 A1
(43) Pub. Date: Sep. 10, 2026

(54) INFORMATION PROCESSING DEVICE, DETERMINATION METHOD, AND PROGRAM RECORDING MEDIUM

(71) Applicant: NEC CORPORATION, Tokyo (JP)

(72) Inventors: Yuko OHTA, Tokyo (JP); Akihiro NAKAMURA, Tokyo (JP)

(73) Assignee: NEC CORPORATION, Tokyo (JP)

(21) Appl. No.: 19/166,905

(22) PCT Filed: Mar. 29, 2023
(86) PCT No.: PCT/JP2023/012724

§ 371 Date: Sep. 19, 2025

(51) Int. Cl. G06Q 10/0637

(52) U.S. Cl. CPC G06Q 10/0637

(57) ABSTRACT

An information processing device includes, at least one memory storing instructions, and at least one processor configured to execute the instructions to, acquire a goal registered in a goal sharing service that receives registration of the goals from a plurality of users and shares an achievement status of each goal by each user among the users, and determine conformability between the acquired goal and an evaluation criterion for evaluating a user who has registered or achieved the goal.

### TECHNICAL FIELD

The present invention relates to a technology for supporting setting of a goal, a challenge to the set goal, and the like.

### BACKGROUND ART

A technology for supporting a user to achieve a set goal is conventionally known. For example, PTL 1 below discloses a goal achievement support device that generates score data of a personality factor based on an answer of a target person to a question for personality analysis, and outputs a support phrase selected based on the score data, thereby supporting the target person to achieve a goal.

### CITATION LIST

### Patent Literature

PTL 1: JP 2019-109719 A

### SUMMARY OF INVENTION

### Technical Problem

In the goal achievement support device of PTL 1, a target person who tries to achieve a goal sets the goal by himself/herself. However, there are many people who feel that it is difficult to set a goal, and thus the technology of PTL 1 has room for improvement in this respect.

As a measure for improving the above point, for example, it is conceivable to construct a system that accepts registration of a goal from a plurality of users and enables each user to challenge the registered goal. The user who uses such a system can challenge the goal registered by another user without setting the goal by himself/herself, and can also register his/her goal with reference to the goal registered by another user. Thus, with the system, the difficulty of setting a goal can be overcome.

However, in a case where each user can register a goal, there may be a case where an evaluation criterion is not set for the registered goal. Then, for a goal for which an evaluation criterion is not set, there arises a problem that it is difficult to appropriately evaluate a user who has registered or achieved the goal.

An object of one aspect of the present invention is to enable appropriate evaluation of a user who has registered or achieved a goal even if an evaluation criterion is not set for the registered goal.

### Solution to Problem

An information processing device according to an aspect of the present invention includes goal acquisition means for acquiring a goal registered in a goal sharing service that receives registration of the goals from a plurality of users and shares an achievement status of each goal by each user among the users, and conformity determination means for determining conformability between the acquired goal and an evaluation criterion for evaluating a user who has registered or achieved the goal.

A determination method according to an aspect of the present invention causes at least one processor to perform acquiring a goal registered in a goal sharing service that receives registration of the goals from a plurality of users and shares an achievement status of each goal by each user among the users, and determining conformability between the acquired goal and an evaluation criterion for evaluating a user who has registered or achieved the goal.

A determination program according to an aspect of the present invention causes a computer to function as goal acquisition means for acquiring a goal registered in a goal sharing service that receives registration of the goals from a plurality of users and shares an achievement status of each goal by each user among the users, and conformity determination means for determining conformability between the acquired goal and an evaluation criterion for evaluating a user who has registered or achieved the goal.

### Advantageous Effects of Invention

According to one aspect of the present invention, even in a case where an evaluation criterion is not set for a registered goal, it is possible to appropriately evaluate a user who has registered or achieved the goal.

### BRIEF DESCRIPTION OF DRAWINGS

FIG. 1 is a block diagram illustrating a configuration of an information processing device according to a first example embodiment of the present invention.

FIG. 2 is a flowchart illustrating a flow of a determination method according to the first example embodiment of the present invention.

FIG. 3 is a diagram illustrating an outline of a goal sharing service.

FIG. 4 is a block diagram illustrating a configuration of an information processing device according to a second example embodiment of the present invention.

FIG. 5 is a diagram illustrating a display example of a conformability determination result.

FIG. 6 is a view illustrating a display example of aggregated data.

FIG. 7 is a flowchart illustrating a flow of processing executed at the time of goal registration by an information processing device according to a second example embodiment of the present invention.

FIG. 8 is a flowchart illustrating a flow of processing executed by the information processing device generating aggregated data according to the second example embodiment of the present invention.

FIG. 9 is a diagram illustrating an example of a computer that executes a command of a program that is software for achieving each function of each apparatus according to each example embodiment.

### EXAMPLE EMBODIMENT

### First Example Embodiment

A first example embodiment of the present invention will be described in detail with reference to the drawings. The present example embodiment is a basic form of the example embodiment to be described later.

### Configuration of Information Processing Device 1

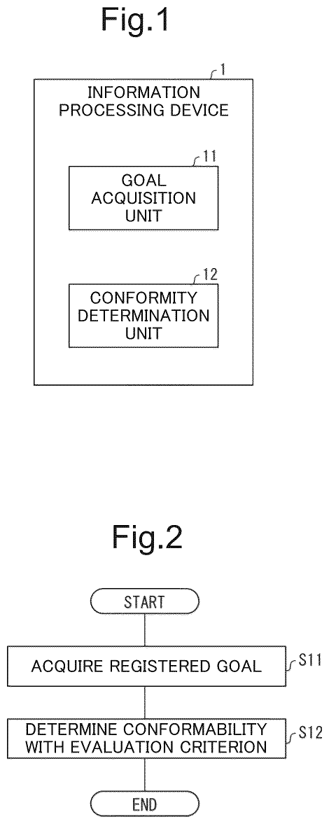

A configuration of an information processing device 1 according to the present example embodiment will be described with reference to FIG. 1. FIG. 1 is a block diagram illustrating a configuration of the information processing device 1. As illustrated in FIG. 1, the information processing device 1 includes a goal acquisition unit 11 and a conformity determination unit 12.

The goal acquisition unit 11 receives registration of goals from a plurality of users, and acquires a goal registered in a goal sharing service for sharing an achievement status by each user of each goal among the users.

The conformity determination unit 12 determines conformability between the goal acquired by the goal acquisition unit 11 and an evaluation criterion for evaluating the user who has registered or achieved the goal.

As described above, the information processing device 1 according to the present example embodiment includes the goal acquisition unit 11 for receiving registration of a goal from a plurality of users and acquiring the goal registered in a goal sharing service for sharing an achievement status of each goal by each user among users, and the conformity determination unit 12 for determining conformability between the acquired goal and an evaluation criterion for evaluating a user who has registered or achieved the goal. Therefore, according to the information processing device 1, even in a case where the evaluation criterion is not set for the registered goal, it is possible to appropriately evaluate the user who has registered or achieved the goal.

### Determination Program

The functions of the above-described information processing device 1 can also be achieved by a program. A determination program according to the present example embodiment causes a computer to function as goal acquisition means for receiving registration of a goal from a plurality of users and acquiring the goal registered in a goal sharing service for sharing an achievement status of each goal by each user among users, and conformity determination means for determining conformability between the acquired goal and an evaluation criterion for evaluating a user who has registered or achieved the goal. According to the determination program, even in a case where an evaluation criterion is not set for a registered goal, it is possible to appropriately evaluate a user who has registered or achieved the goal.

### Flow of Determination Method

A flow of a determination method according to the present example embodiment will be described with reference to FIG. 2. FIG. 2 is a flowchart illustrating the flow of the determination method. An executing entity of each step in the determination method may be a processor included in the information processing device 1 or may be a processor included in another apparatus, or executing entities of the steps may be processors provided in mutually different apparatuses.

In S1, at least one processor receives registration of goals from a plurality of users, and acquires a goal registered in a goal sharing service for sharing an achievement status by each user of each goal among the users.

In S2, at least one processor determines conformability between the goal acquired in S1 and an evaluation criterion for evaluating the user who has registered or achieved the goal.

As described above, in the determination method according to the present example embodiment, at least one processor performs acquiring a goal registered in a goal sharing service that receives registration of the goals from a plurality of users and shares an achievement status of each goal by each user among the users, and determining conformability between the acquired goal and an evaluation criterion for evaluating a user who has registered or achieved the goal. Therefore, according to the determination method according to the present example embodiment, even in a case where an evaluation criterion is not set for a registered goal, it is possible to appropriately evaluate a user who has registered or achieved the goal.

### Second Example Embodiment

### Outline of Goal Sharing Service

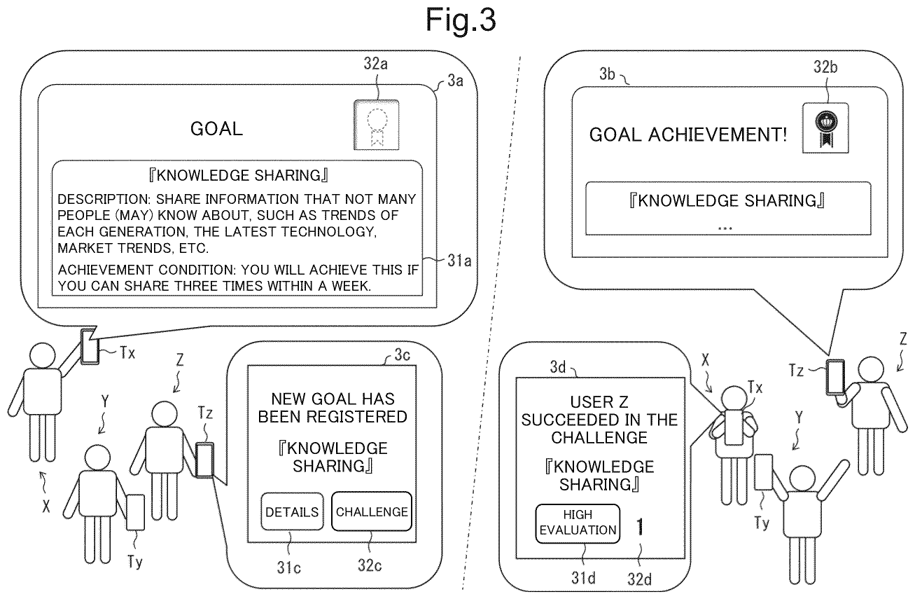

An information processing device 2 according to the present example embodiment is a device used in a goal sharing service that receives registration of a goal from a plurality of users and shares an achievement status of each goal by each user among the users. More specifically, the information processing device 2 is a device that determines conformability between a goal registered in the goal sharing service and an evaluation criterion for evaluating a user who has registered or achieved the goal. Here, prior to the description of the information processing device 2, an outline of the goal sharing service will be described with reference to FIG. 3.

FIG. 3 is a diagram illustrating an outline of the goal sharing service. The goal sharing service receives registration of the goal from the plurality of users. The left side of FIG. 3 illustrates an example in which a user X who possesses a terminal device Tx among three users X to Z registers a goal in the goal sharing service.

An image 3a indicating the registered goal is displayed on a display unit of the terminal device Tx. The image 3a includes a content display field 31a that displays the content of the goal and an achievement status display field 32a that displays the achievement status of the goal. In the achievement status display field 32a, a medal icon is displayed by a broken line, and the icon drawn by the broken line indicates that the goal is not achieved.

In the content display field 31a, a character string “knowledge sharing” which is a title of the registered goal is displayed, and description and an achievement condition of the goal are displayed. These are all input and registered by the user X via a terminal device Tx. In this manner, the user of the goal sharing service can register a goal with any content. The target person to which the goal sharing service is provided is not particularly limited. For example, the target may be an employee of a company or the like, or a student of a school or the like, a player in sports, or the like.

In the goal sharing service, the goal registered as described above is shared among users of the service. That is, the user X can challenge the goal registered by the user X, and users such as the users Y and Z who do not register the goal can also challenge the goal.

Therefore, if a new goal is registered, the fact may be notified to each user of the goal sharing service. In the example of FIG. 3, a message screen 3c indicating that a new goal has been registered is displayed on a display screen of a terminal device Tz possessed by a user Z. Although not illustrated, a similar screen can be browsed from a terminal device Ty of the user Y.

On the message screen 3c, a title of a registered goal and a sentence indicating that the goal has been registered are displayed, a key 31c for displaying detailed contents of the registered goal, and a key 32c for starting a challenge to the goal are displayed. If the user Z selects the key 31c, the description of the goal and the achievement condition are displayed on the terminal device Tz. If the user Z selects the key 32c, the fact that the user Z starts to challenge the goal is registered in the goal sharing service.

The above-described notification may be made by transmitting a message to each user using, for example, an electronic mail or the like, or may be made by posting a message on a timeline or the like browsable by each user of the goal sharing service. The notification target may be all or some of the users of the goal sharing service. For example, only a user registered as a member of the same group as the user who has registered the goal may be set as the notification target. The same applies to notification of a message 3d to be described later.

The right side of FIG. 3 illustrates an example in which the user Z carrying the terminal device Tz has achieved the goal registered as described above. An image 3b is displayed on a display unit of the terminal device Tz possessed by the user Z. An icon of a medal is displayed in an achievement status display field 32b in the image 3b, and this icon indicates that the goal has been achieved. How to notify an achiever that the goal has been achieved is not particularly limited.

In the goal sharing service, achievement of a goal is also shared among users. For example, in the example of FIG. 3, a message screen 3d indicating that the goal has been achieved is displayed on the display screen of the terminal device Tx possessed by the user X. Although not illustrated, a similar screen can be browsed from a terminal device Ty of the user Y.

On the message screen 3d, the title of the achieved goal and the name of the achieved user are displayed, a key 31d for positively evaluating the goal achievement, and a number 32d indicating the number of times of positive evaluation in the goal sharing service are displayed. If the user X selects the key 31d, the number 32d is incremented. A message to the user Z who has achieved the goal may be posted from the message screen 3d.

### Configuration of Information Processing Device 2

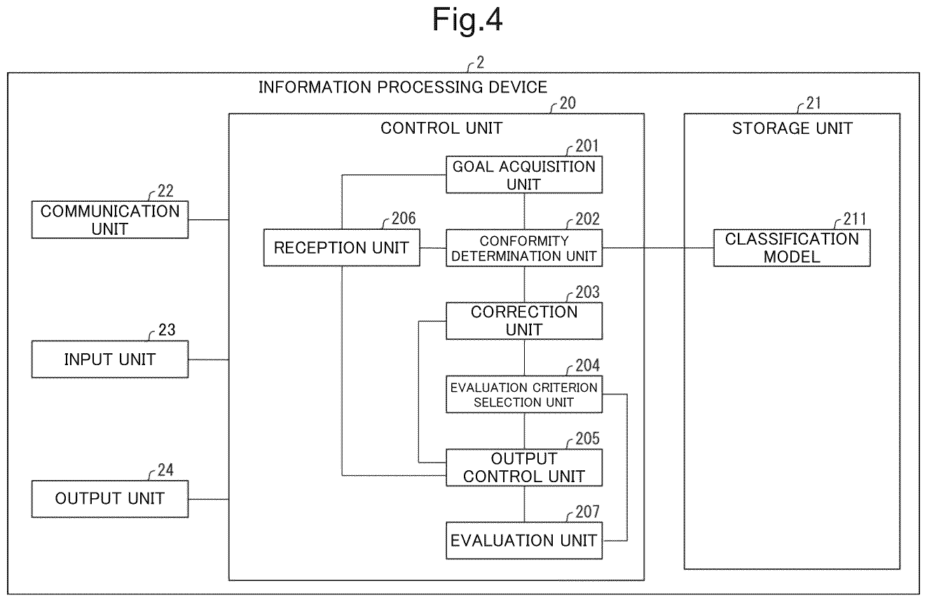

A configuration of an information processing device 2 according to the present example embodiment will be described with reference to FIG. 4. FIG. 4 is a block diagram illustrating the configuration of the information processing device 2. As described above, the information processing device 2 is a device that determines conformability between a goal registered in the goal sharing service and an evaluation criterion.

As illustrated, the information processing device 2 includes a control unit 20 that integrally controls each unit of the information processing device 2 and a storage unit 21 that is a storage device that stores various data used by the information processing device 2. The information processing device 2 includes a communication unit 22 for the information processing device 2 to communicate with another apparatus, an input unit 23 that receives an input to the information processing device 2, and an output unit 24 for the information processing device 2 to output data. The control unit 20 includes a goal acquisition unit 201, a conformity determination unit 202, a correction unit 203, an evaluation criterion selection unit 204, an output control unit 205, a reception unit 206, and an evaluation unit 207, and the storage unit 21 stores a classification model 211.

The goal acquisition unit 201 acquires a goal registered in the goal sharing service. As described with reference to FIG. 3, the goal sharing service is a service that receives registration of goals from a plurality of users and allows users to share an achievement status of each goal by each user. Here, the goal is set to achieve a certain purpose. The acquisition of the goal means acquisition of data representing the goal in any format such as text.

The conformity determination unit 202 determines conformability between the goal acquired by the goal acquisition unit 201 and an evaluation criterion registered in advance for evaluating a user who has registered or achieved the goal. Any evaluation criteria can be registered, and a plurality of evaluation criteria can also be registered. For example, in a case where a total of three evaluation criteria of “ambition”, “contribution to a team”, and “foresight” are registered, the conformity determination unit 202 determines the conformability between the goal acquired by the goal acquisition unit 201 and these three evaluation criteria. As a result, it is possible to perform evaluation to which an evaluation criterion suitable for the acquired goal is applied.

Although details will be described later, the conformity determination unit 202 calculates the degree of conformity indicating the conformability between the goal and the evaluation criterion using the classification model 211. The classification model 211 is a model that classifies a goal represented by a text into evaluation criteria that conform to the goal.

The correction unit 203 corrects the degree of conformity calculated by the conformity determination unit 202. Details of the degree of conformity and its correction method will be described later. In a case where correction of the degree of conformity is unnecessary, the correction unit 203 is omitted.

The evaluation criterion selection unit 204 selects an evaluation criterion to be used for evaluation of a target user to be evaluated among users of the goal sharing service from a plurality of evaluation criteria set in advance based on a determination result of conformability by the conformity determination unit 202. The evaluation criterion selection unit 204 may select the evaluation criteria based on the user-related information regarding the target user, or may select the evaluation criteria based on both the determination result of conformability and the user-related information. Details of the user-related information and a method of selecting the evaluation criteria will be described later.

The output control unit 205 causes the output device to output various types of information regarding the goal sharing service. An output mode of the information is not particularly limited, and an output device which is an output destination of the information is also not particularly limited. For example, the output control unit 205 may cause a device used by the user of the goal sharing service, such as the terminal devices Tx to Tz illustrated in FIG. 3, to output the information, or may cause the output unit 24 included in the information processing device 2 to output the information. The output mode of the information may be, for example, display output, voice output, print output, or the like, or a plurality of output modes may be used in combination.

The reception unit 206 receives goal correction. In a case where the goal has been corrected, the conformity determination unit 202 determines the conformability between the corrected goal and the evaluation criteria. As a result, the user who registers the goal can correct the registered goal in such a way as to conform to a desired evaluation criterion and then re-register the goal.

The evaluation unit 207 evaluates the user of the goal sharing service. More specifically, the evaluation unit 207 evaluates the user from two viewpoints of achievement of the goal and registration. In any evaluation, the evaluation criteria selected by the evaluation criterion selection unit 204 are applied. Whether the goal has been achieved may be determined based on a self-report by the user who has achieved the goal, or an evaluator such as a superior of the user may determine whether the goal has been achieved, and a determination result may be input to the information processing device 2.

As described above, the information processing device 2 includes the goal acquisition unit 201 for receiving registration of a goal from a plurality of users and acquiring the goal registered in a goal sharing service for sharing an achievement status of each goal by each user among users, and the conformity determination unit 202 for determining conformability between the acquired goal and an evaluation criterion for evaluating a user who has registered or achieved the goal. Therefore, even in a case where the evaluation criterion is not set for the registered goal, it is possible to appropriately evaluate the user who has registered or achieved the goal.

The conformity determination unit 202 determines the conformability between the goal represented by the text and the evaluation criteria by using the classification model 211 that classifies the goal represented by the text into the evaluation criteria that conform to the goal. As a result, in addition to the effects obtained by the information processing device 1 according to the first example embodiment, it is possible to obtain an effect that it is possible to determine conformability between the goal represented by the text and the evaluation criteria.

As described above, the information processing device 2 includes the reception unit 206 that receives correction of the goal, and the conformity determination unit 202 determines the conformability between the goal after the correction and the evaluation criterion in a case where the goal has been corrected. As a result, in addition to the effects obtained by the information processing device 1 according to the first example embodiment, it is possible to correct the goal based on the determination result of conformability, and it is possible to confirm whether the corrected goal conforms to the evaluation criteria.

### Method for Determining Conformability

For example, the conformity determination unit 202 may determine the conformability by using a classification model 211 generated by machine learning using teacher data in which an evaluation criterion conforming to a goal is associated as correct answer data with a feature amount generated from the goal represented by a text.

In this case, the conformity determination unit 202 generates a feature amount from a goal represented by a text and inputs the feature amount to the classification model 211. As a result, the classification model 211 outputs a higher numerical value (for example, a numerical value up to 0 to 1) for a goal having the higher possibility of conforming to the evaluation criteria. This numerical value is hereinafter referred to as degree of conformity. The extraction of the feature amount may also be performed by the classification model 211 (that is, the classification model 211 that performs both the extraction and the classification of the feature amount is used). In this case, the conformity determination unit 202 may input a text indicating the goal to the classification model 211.

The conformity determination unit 202 may use the degree of conformity as a conformability determination result. For example, it is assumed that the classification model 211 learned by using teacher data in which an appropriate evaluation criterion is associated as correct answer data with respect to a plurality of goals conforming to any one of the three evaluation criteria is used. In this case, since the degree of conformity for each of the three evaluation criteria is output from the classification model 211, the conformity determination unit 202 may use the degree of conformity as the conformability determination result.

The conformability determination method is not limited to the above example. For example, the conformity determination unit 202 may determine whether the goal conforms to the evaluation criteria by comparing the calculated degree of conformity with a threshold or the like. In this case, the conformability determination result indicates a conforming evaluation criterion. For example, in a case where a threshold of the degree of conformity is 0.6, it is assumed that the degree of conformity of a certain goal to three evaluation criteria is 0.7, 0.2, and 0.1. In this case, the conformity determination unit 202 determines that the goal conforms to the first evaluation criterion, and outputs information indicating the first evaluation criterion as a determination result.

The conformity determination unit 202 may determine the conformability between the goal and the evaluation criterion by comparing the feature amount generated from the text representing the goal with the feature amount generated from the text representing the evaluation criterion. For example, the conformity determination unit 202 may calculate cosine similarity between a feature amount generated from a text representing a goal and a feature amount generated from a text representing an evaluation criterion as the degree of conformity of the goal to the evaluation criterion.

### Method of Correcting Degree of Conformity

A method of correcting the degree of conformity by the correction unit 203 may be determined in advance. For example, the correction unit 203 may correct the degree of conformity based on user-related information related to a target user to be evaluated among users of the goal sharing service.

For example, in a case where an evaluation criterion to be emphasized in the evaluation of the target user is registered by an evaluator in a position to evaluate the target user such as a supervisor of the target user, the correction unit 203 may correct the degree of conformity using the evaluation criterion as the user-related information. Similarly, in a case where the target user registers an evaluation criterion that the target user wants to emphasize as, for example, an annual goal or the like, the correction unit 203 may correct the degree of conformity using the evaluation criterion as the user-related information.

In these cases, the correction unit 203 may correct the degree of conformity to the evaluation criteria that an evaluator or the target user wants to emphasize in such a way as to have a larger value. For example, in a case where an evaluation criterion to be emphasized is “ambition”, the correction unit 203 may perform correction of multiplying the degree of conformity of the “ambition” calculated by the conformity determination unit 202 by a weight larger than 1. The weight may be set in advance.

In a case where the category is set for the registered goal, the correction unit 203 may correct the degree of conformity using the category. For example, for each evaluation criterion, a weight associated with conformability with various categories may be set in advance. As a result, the correction unit 203 can correct the degree of conformity by multiplying the degree of conformity by the weight associated with the category.

For example, it is assumed that a category of a concept included in a part of a plurality of evaluation criteria or a category of a concept similar to a part of a plurality of evaluation criteria is set for a certain goal. For example, in a case where a category of “skill up” included in the evaluation criterion of “ambition” is set, the correction unit 203 may perform correction of multiplying the degree of conformity of the evaluation criterion by a weight of a value larger than 1. As a result, the degree of conformity can be corrected to a value associated with the category set as the goal.

For example, in a case where an evaluation criterion regarding work is set, it is assumed that a category set to a certain goal is a category indicating that the goal is a private goal that is not directly related to work (for example, a category such as “health management”). In this case, the correction unit 203 may correct the degree of conformity to the evaluation criteria to a lower value by, for example, multiplying the degree of conformity by a weight less than 1.

In this manner, a goal having a high possibility of not conforming with the set evaluation criteria may be excluded from the target for conformability determination and evaluation. However, it is preferable to allow the registration of private goals. This is to contribute to improvement of the use frequency of the goal sharing service and habituation of use.

### Display Example of Conformability Determination Result

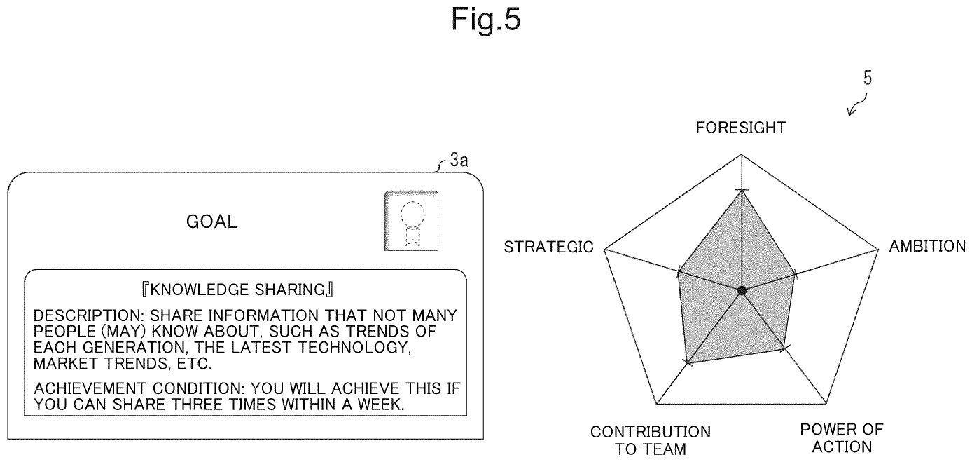

FIG. 5 is a diagram illustrating a display example of a conformability determination result by the conformity determination unit 202. More specifically, FIG. 5 illustrates a graph 5 illustrating a conformability determination result together with an image 3a (the same as that illustrated in FIG. 3) indicating a registered goal. A graph 5 is a radar chart showing the degree of conformity of the goal shown in image 3a to five evaluation criteria: foresight, ambition, power of action, contribution to a team, and strategic. The degree of conformity may be corrected by the correction unit 203.

The output control unit 205 may display the determination result of the conformity determination unit 202 by such a graph. As a result, it is possible to allow the user to recognize at a glance how much the goal conforms with what kind of evaluation criteria.

The output control unit 205 may display the evaluation criteria selected by the evaluation criterion selection unit 204. In this case, it is possible to present, to the user, one or some of the plurality of evaluation criteria that conform to the goal (which can also be referred to as evaluation criterion or criteria for evaluation).

In the goal sharing service, the goal can be corrected. For example, the reception unit 206 may receive a correction to at least one of the title, the description, and the achievement condition on the image 3a. The reception unit 206 may receive a correction of associating a category with the goal.

If the reception unit 206 receives the correction of the goal, the conformity determination unit 202 calculates the degree of conformity between the goal after the correction and the evaluation criterion. Then, the output control unit 205 displays the newly calculated degree of conformity. At this time, the output control unit 205 may display a radar chart indicating the degree of conformity between the goal before correction and each evaluation criterion and a radar chart indicating the degree of conformity between the goal after correction and each evaluation criterion in a superimposed manner on one graph. As a result, it is possible to make the user recognize how much the goal correction has affected the degree of conformity to which evaluation criterion.

### Method of Selecting Evaluation Criteria

A method of selecting the evaluation criteria by the evaluation criterion selection unit 204 may also be determined in advance. For example, the evaluation criterion selection unit 204 may select a predetermined number of evaluation criteria in descending order of degree of conformity (which may be corrected by the correction unit 203) calculated by the conformity determination unit 202. The selection number of the evaluation criteria is determined in advance. For example, the evaluation criterion selection unit 204 may select one or a plurality of evaluation criteria in which the degree of conformity (which may be corrected by the correction unit 203) calculated by the conformity determination unit 202 is equal to or more than a predetermined threshold.

The evaluation criterion selection unit 204 may select an evaluation criterion to be used for evaluation of a target user to be evaluated among users of the goal sharing service from a plurality of evaluation criteria set in advance based on user-related information regarding the target user and a determination result of conformability. As a result, in addition to the effect obtained by the information processing device 1 according to the first example embodiment, an effect of being able to select the evaluation criteria according to the target user can be obtained.

A method of selecting the evaluation criteria based on the user-related information may also be determined in advance. For example, the evaluation criterion selection unit 204 may select the evaluation criterion having the highest degree of conformity corrected by the correction unit 203 based on the user-related information as the evaluation criterion to be used for evaluation of the target user.

For example, in a case where predetermined user-related information is acquired, the evaluation criterion selection unit 204 may preferentially select an evaluation criterion associated with the user-related information. For example, the evaluation criterion selection unit 204 may acquire information (for example, an annual goal) indicating an evaluation criterion that the target user or the evaluator thereof wants to emphasize as the user-related information. In this case, the evaluation criterion selection unit 204 may select the evaluation criterion indicated in the user-related information among the evaluation criteria of which degree of conformity (which may be corrected or uncorrected) is higher (or equal to or more than a predetermined threshold). The evaluation criterion selection unit 204 may select the evaluation criterion indicated in the user-related information regardless of the degree of conformity.

The evaluation criterion selection unit 204 may change the method of selecting the evaluation criteria according to the value of the degree of conformity calculated by the conformity determination unit 202. For example, the evaluation criterion selection unit 204 may select the evaluation criterion with reference to the user-related information in a case where it is difficult to select the evaluation criterion optimal for the evaluation of the target user only based on the degree of conformity, such as a case where the degree of conformity calculated by the conformity determination unit 202 for a plurality of evaluation criteria is within a range of 0.45 to 0.55.

### Display Example of Aggregated Data

The evaluation unit 207 evaluates a user who has achieved the goal registered in the goal sharing service, and also evaluates a user who has registered the goal. Then, in these evaluations, the evaluation criteria selected by the evaluation criterion selection unit 204 are applied. That is, the evaluation unit 207 evaluates the target user based on the evaluation criteria selected by the evaluation criterion selection unit 204 for each goal registered or achieved by the target user to be evaluated.

Specifically, the evaluation unit 207 generates aggregated data obtained by aggregating the evaluation criteria selected by the evaluation criterion selection unit 204 for each goal registered or achieved by the target user as data indicating the evaluation result of the target user.

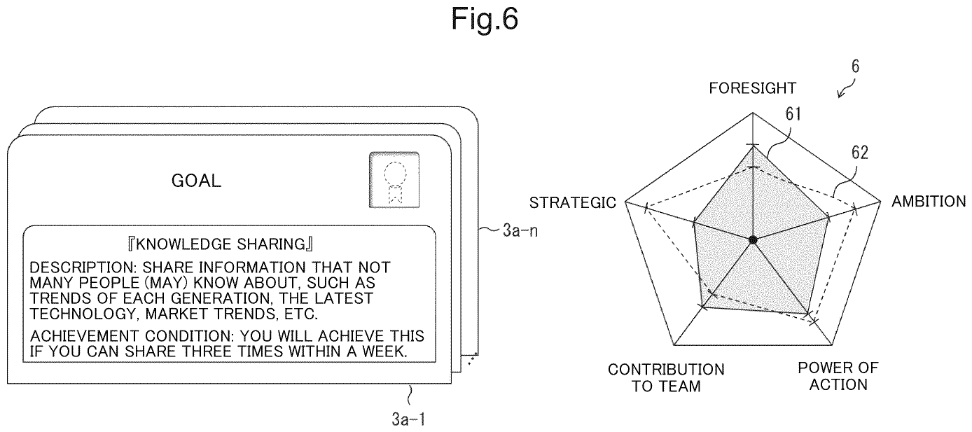

FIG. 6 is a diagram illustrating a display example of aggregated data. More specifically, FIG. 6 illustrates a graph 6 in which the number of goals registered by the target user is aggregated for each evaluation criterion together with images 3a-1 to 3a-n indicating n (n is an integer of 2 or more) goals registered by the target user. A graph 6 is an example of the aggregated data described above, and is a radar chart showing a result of aggregating the number of evaluation criteria (any one of foresight, ambition, power of action, contribution to a team, and strategic) selected by the evaluation criterion selection unit 204 for each goal shown in the images 3a-1 to 3a-n.

The output control unit 205 may display the selection result of the evaluation criteria for each goal by the evaluation criterion selection unit 204 with such a graph. As a result, it is possible to allow the user to recognize at a glance how many goals conforming to what evaluation criteria have been registered. Similarly, the evaluation unit 207 may generate, as aggregated data, a graph obtained by aggregating the number of goals achieved by the target user for each evaluation criterion.

In the aggregation described above, weighting by the degree of conformity may be performed. For example, in a case where the degree of conformity of the evaluation criterion “foresight” selected for a certain goal is 0.7 and the degree of conformity of the evaluation criterion “foresight” selected for another goal is 0.3, the evaluation unit 207 may set the aggregation result of the evaluation criterion “foresight” to 0.3+0.7=1.0. The aggregated data is not necessarily required to be a graph, and for example, the output control unit 205 may display a numerical value indicating the number of goals for each evaluation criterion.

As described above, the information processing device 2 includes an output control unit 205 that causes the output device to output aggregated data obtained by aggregating the evaluation criteria selected by the evaluation criterion selection unit 204 for the goal registered or achieved by the target user. This provides the effect of allowing the target user to recognize what evaluation criteria are associated with the goals that he or she has registered or achieved so far, in addition to the effect provided by the information processing device 1 of the first example embodiment.

The graph 6 includes radar charts 61 and 62. These are aggregated data generated for goals registered by the target user in different periods. Specifically, a radar chart 61 indicates a result of aggregating the number of goals registered by the target user in the latest predetermined period for each evaluation criterion selected by the evaluation criterion selection unit 204. On the other hand, a radar chart 62 indicates a result of aggregating the number of goals registered by the target user before the predetermined period for each evaluation criterion selected by the evaluation criterion selection unit 204.

By superimposing and displaying the radar charts 61 and 62 on one graph, it is possible to recognize at a glance how the evaluation criteria of the goal most recently registered by the target user have changed from the evaluation criteria of the goal previously registered. Similarly, it is also possible to display the aggregation results in three or more periods. The output control unit 205 may display aggregated data (may be a graph or no graph) obtained by aggregating the number of goals achieved by the target user in a plurality of different periods for each evaluation criterion in a similar manner.

As described above, the output control unit 205 may display the aggregated data generated for the goal registered or achieved by the target user in a plurality of different periods in association with each other. As a result, in addition to the effect obtained by the information processing device 1 according to the first example embodiment, it is possible to obtain an effect of being able to recognize the transition of the evaluation criteria of the goal registered or achieved by the target user.

In the above case, the evaluation unit 207 may set a period in such a way that the number of goals in each period is equal, or may normalize the number of times associated with each evaluation criterion to obtain aggregated data. This makes it possible to accurately recognize the transition of the goal evaluation criteria in each period.

The evaluation unit 207 may generate an evaluation result obtained by comprehensively evaluating the registered goal and the achieved goal. For example, the evaluation unit 207 may calculate a score for each evaluation criterion for each registered goal, calculate a score for each evaluation criterion for an achieved goal, and sum the scores for each evaluation criterion to obtain an evaluation result.

A method of calculating the score may be determined in advance. For example, the score may be calculated according to a rule that, for registration of a goal, each time one goal is registered, +10 points are added to the evaluation criteria that conform to the goal, and for achievement of the goal, each time one goal is achieved, +15 points are added to the evaluation criteria that conform to the goal. In this case, the output control unit 205 may display the score calculated for each evaluation criterion as a radar chart as illustrated in FIG. 6, for example.

### Flow of Processing at Goal Registration

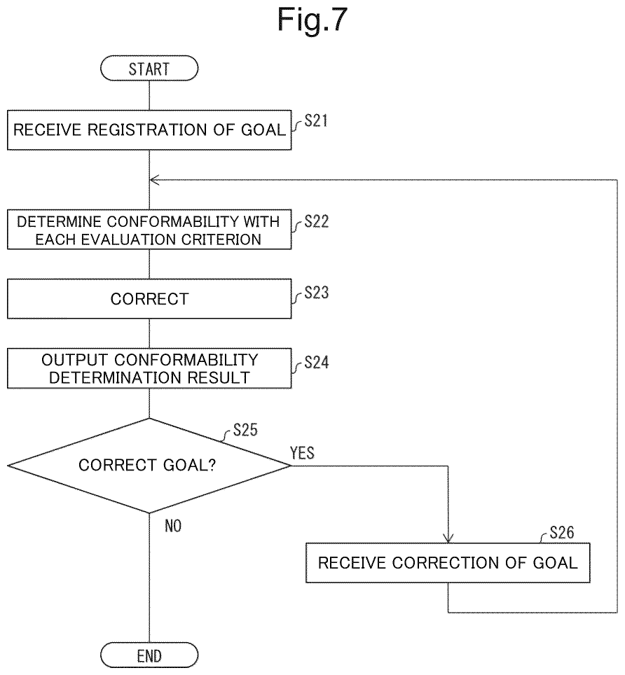

A flow of processing executed by the information processing device 2 at the time of registering a goal will be described with reference to FIG. 7. FIG. 7 is a flowchart illustrating a flow of processing executed by the information processing device 2 at the time of goal registration.

Hereinafter, an example in which a goal is registered by the terminal device Tx illustrated in FIG. 3 will be described.

In S21, the goal acquisition unit 201 receives the registration of the goal. Specifically, the goal acquisition unit 201 receives registration of a goal by the terminal device Tx by communication via the communication unit 22, and thus, the goal (specifically, text indicating the goal) is acquired. As described above, processing of acquiring the goal by the goal acquisition unit 201 may be processing of receiving registration of the goal.

In S22, the conformity determination unit 202 determines the conformability between the goal acquired in S21 and each evaluation criterion. Specifically, the conformity determination unit 202 generates a feature amount from the text representing the goal acquired in S21 and inputs the feature amount to the classification model 211, thereby calculating the degree of conformity indicating the conformability to the goal for each of the plurality of evaluation criteria. That is, although it is assumed here that a plurality of evaluation criteria is registered in advance, at least one evaluation criterion may be registered.

In S23, the correction unit 203 corrects the degree of conformity calculated in S22. For example, the correction unit 203 may acquire information indicating an evaluation criterion emphasized by the user as the user-related information and perform correction in such a way as to increase the degree of conformity to the evaluation criterion.

In S24, the output control unit 205 outputs the degree of conformity corrected in S23 as a conformability determination result. For example, the output control unit 205 may output the degree of conformity corrected in S23 to the terminal device Tx by communication via the communication unit 22. The output mode of the degree of conformity is not particularly limited, and for example, the output control unit 205 may present degree of conformity to each evaluation criterion by displaying a radar chart as illustrated in FIG. 5.

In S25, the reception unit 206 determines whether to correct the goal. For example, in a case of detecting that an input operation for correcting the goal is performed on the terminal device Tx, the reception unit 206 may determine to correct the goal (YES in S25). In a case of detecting that an input operation for fixing the goal is performed without correcting the goal, the reception unit 206 may determine that the goal is not corrected (NO in S25). If YES is determined in S25, the processing proceeds to S26, and If NO is determined in S25, the illustrated processing ends.

In S26, the reception unit 206 receives goal correction. Foi example, the reception unit 206 receives goal correction from the terminal device Tx by communication via the communication unit 22. Thereafter, the processing returns to S22, and conformability is determined for the goal after correction.

S21 and S22 in the flowchart of FIG. 7 show a determination method according to the present example embodiment. That is, the determination method shown in FIG. 7 includes acquiring a goal registered in a goal sharing service that receives registration of the goals from a plurality of users and shares an achievement status of each goal by each user among the users, and determining conformability between the acquired goal and an evaluation criterion for evaluating a user who has registered or achieved the goal. Therefore, even in a case where the evaluation criterion is not set for the registered goal, it is possible to appropriately evaluate the user who has registered or achieved the goal.

Each user of the goal sharing service can select and challenge a goal suitable for the user from among the registered goals as described above. The start of the challenge to the goal is received by the reception unit 206, for example, and the fact is registered in the goal sharing service. The fact that the user has started to challenge the goal is notified to another user (may be limited to a user in the same group as the user who challenges) by the output control unit 205, for example. Then, if the user has achieved the goal, the achievement of the goal is registered in the goal sharing service, and for example, the output control unit 205 notifies another user (who may be limited to a user in the same group as the user who challenges) of the achievement of the goal.

After starting the challenge, it is also assumed that the user feels that the challenge is difficult to achieve or determines that the challenge is not suitable for the user. Therefore, the reception unit 206 may accept withdrawal of the challenge. In a case of accepting the withdrawal of the challenge, the reception unit 206 deletes the goal to be withdrawn from a list of goals being challenged by the user who has withdrawn the challenge.

### Flow of Processing at the Time of Generating Aggregated Data

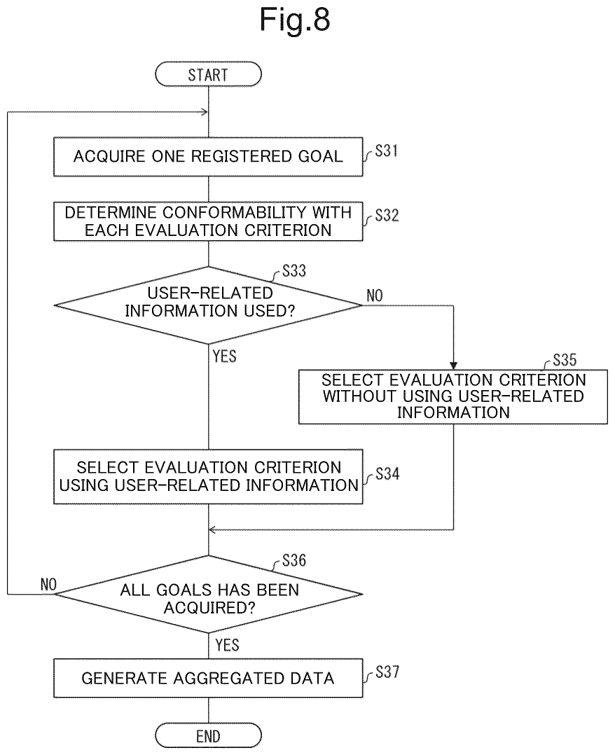

A flow of processing executed by the information processing device 2 at the time of generating aggregated data will be described with reference to FIG. 8. FIG. 8 is a flowchart illustrating a flow of processing executed by the information processing device 2 at the time of generating aggregated data. Hereinafter, an example of generating the aggregated data of the user X illustrated in FIG. 3 will be described.

In S31, the goal acquisition unit 201 acquires one goal registered in the goal sharing service by the user X. The goal registered by each user is recorded in the storage unit 21 or the like in association with identification information of each user.

In S32, the conformity determination unit 202 determines the conformability between the goal acquired in S31 and each evaluation criterion. Specifically, the conformity determination unit 202 generates a feature amount from the text representing the goal acquired in S21 and inputs the feature amount to the classification model 211, thereby calculating the degree of conformity indicating the conformability to the goal for each of the plurality of evaluation criteria. That is, although it is assumed here that a plurality of evaluation criteria is registered in advance, at least one evaluation criterion may be registered.

In S33, the evaluation criterion selection unit 204 determines whether to select an evaluation criterion using the user-related information. A determination criterion as to whether to use the user-related information may be determined in advance. For example, in a case where one evaluation criterion is selected for one goal, the user-related information may be used in a case where a difference between the maximum value and the second largest value of the degree of conformity calculated for each evaluation criterion is equal to or less than a predetermined threshold. If YES is determined in S33, the processing proceeds to S34, and if NO is determined in S33, the processing proceeds to S35. The processing of S33 may be omitted. In this case, the evaluation criteria may be always selected using the user-related information, or the evaluation criteria may be always selected without using the user-related information.

In S34, the evaluation criterion selection unit 204 acquires the user-related information of the user X and selects the evaluation criterion using the acquired user-related information. For example, in a case where information indicating an evaluation criterion that the user X wants to emphasize is acquired as the user-related information, the evaluation criterion selection unit 204 may select the evaluation criterion. In a case where a category is set to the goal acquired in S31, the evaluation criterion selection unit 204 may select the evaluation criterion in consideration of the set category. Thereafter, the processing proceeds to S36.

On the other hand, in S35, the evaluation criterion selection unit 204 selects the evaluation criteria without using the user-related information. For example, the evaluation criterion selection unit 204 may select a predetermined number of evaluation criteria in descending order of degree of conformity. Thereafter, the processing proceeds to S36.

In S36, the goal acquisition unit 201 determines whether all the goals registered by the user X have been acquired. If YES is determined in S36, the processing proceeds to S37. On the other hand, if NO is determined in S36, the processing returns to S31, and the goal acquisition unit 201 acquires one of the unacquired goals among the goals registered by the user X.

In S37, the evaluation unit 207 generates aggregated data based on the results of the processing in S31 to S36. For example, the evaluation unit 207 may generate the radar chart 61 as illustrated in FIG. 6 as the aggregated data. The output control unit 205 may cause the terminal device Tx to output the generated aggregated data.

The aggregated data may not be output. For example, the processing of FIG. 8 may be executed in response to registration or achievement of a predetermined number of goals or arrival of a predetermined date. In this case, the generated aggregated data may be stored in the storage unit 21 or the like without being output. As a result, in a case where the user has performed an operation for browsing the aggregated data, the stored aggregated data can be read and promptly presented.

By setting the goal acquired in S31 as a goal registered in a predetermined period, aggregated data of the predetermined period can be generated. Then, by repeatedly performing the processing of FIG. 8 with the periods being different from each other, aggregated data of different periods can be generated and output in association with each other.

In the above description, an example of generating aggregated data for registered goals has been described; however, the evaluation unit 207 can similarly generate aggregated data for achieved goals. As described above, the evaluation unit 207 may generate an evaluation result obtained by comprehensively evaluating the goal achieved by the target user and the registered goal.

S31 and S32 in the flowchart of FIG. 8 configure a determination method according to the present example embodiment. That is, the determination method shown in FIG. 8 includes acquiring a goal registered in a goal sharing service that receives registration of the goals from a plurality of users and shares an achievement status of each goal by each user among the users, and determining conformability between the acquired goal and an evaluation criterion for evaluating a user who has registered or achieved the goal. Therefore, even in a case where the evaluation criterion is not set for the registered goal, it is possible to appropriately evaluate the user who has registered or achieved the goal.

### Modified Example

An executing entity of each processing described in the above-described example embodiments is optional, and is not limited to the above-described examples. For example, a system having functions similar to those of the information processing apparatuses 1 and 2 can be configured by a plurality of apparatuses capable of communicating with each other. The execution subject of each processing illustrated in each of the flowcharts illustrated in FIGS. 7 and 8 may be one device (also referred to as a processor) or a plurality of devices (also referred to as a processor).

### Example of Implementation by Software

Some or all of the functions of the information processing devices 1 and 2 may be implemented by a logic circuit (hardware) formed in an integrated circuit (IC chip) or the like, or may be implemented by software.

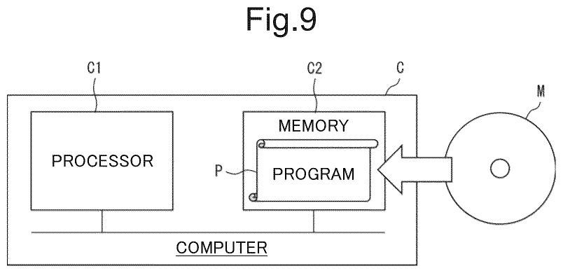

In the latter case, the information processing devices 1 and 2 are achieved by, for example, a computer that executes a command of a program that is software for achieving each function. FIG. 9 illustrates an example of such a computer (hereinafter, referred to as a computer C). The computer C includes at least one processor C1 and at least one memory C2. A program P (determination program) for causing the computer C to operate as the information processing device 1 or 2 is recorded in the memory C2. In the computer C, the processor C1 reads and executes the program P from the memory C2 to implement each function of the information processing device 1 or 2.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the recording medium, a “non-transitory tangible medium”, for example, a tape, a disk, a card, a semiconductor memory, a programmable logic circuit, a combination thereof, or the like can be used in addition to a read only memory (ROM) or the like. A random access memory (RAM) or the like for expanding the program may be further provided. The program may be supplied to the computer via an arbitrary transmission medium (communication network, broadcast wave, or the like) capable of transmitting the program. One aspect of the present invention can also be achieved in a form of a data signal embedded in a carrier wave in which the program is embodied by electronic transmission.

### Supplementary Note 1

The present invention is not limited to the above-described example embodiments, and various modifications can be made within the scope described in the claims. For example, example embodiments obtained by appropriately combining the technical means disclosed in the above-described example embodiments are also included in the technical scope of the present invention.

### Supplementary Note 2

Some or all the above-described example embodiments may be described as follows. However, the present invention is not limited to the following aspects.

An information processing device according to a first aspect includes goal acquisition means for acquiring a goal registered in a goal sharing service that receives registration of the goals from a plurality of users and shares an achievement status of each goal by each user among the users, and conformity determination means for determining the conformability between the acquired goal and an evaluation criterion for evaluating a user who has registered or achieved the goal.

An information processing device according to a second aspect, in the first aspect, further includes evaluation criterion selection means for selecting an evaluation criterion to be used for evaluation of a target user to be evaluated among users of the goal sharing service, from among a plurality of the evaluation criteria set in advance, based on user-related information regarding the target user and a determination result of the conformability.

An information processing device according to a third aspect, in the second aspect, further includes output control means for causing an output device to output aggregated data obtained by aggregating the selected evaluation criteria with respect to a goal registered or achieved by the target user.

In an information processing device according to a fourth aspect, in the third aspect, the output control means causes the aggregated data generated for a goal registered or achieved by the target user in a plurality of different periods to be displayed in association with each other.

In an information processing device according to a fifth aspect, in any one of the first to fourth aspects, the conformity determination means determines conformability between the goal represented by a text and the evaluation criteria by using a classification model that classifies the goal represented by the text into the evaluation criteria that conform to the goal.

An information processing device according to a sixth aspect, in any one of the first to fifth aspects, further includes reception means for receiving correction of the goal, in which the conformity determination means determines conformability between a goal after correction and the evaluation criteria if the goal is corrected.

A determination method according to a seventh aspect causes at least one processor to perform acquiring a goal registered in a goal sharing service that receives registration of the goals from a plurality of users and shares an achievement status of each goal by each user among the users, and determining conformability between the acquired goal and an evaluation criterion for evaluating a user who has registered or achieved the goal.

In a determination method according to an eighth aspect, in the seventh aspect, the conformity determination includes determining conformability between the goal represented by a text and the evaluation criteria by using a classification model that classifies the goal represented by the text into the evaluation criteria that conform to the goal.

A determination program according to a ninth aspect causes a computer to function as goal acquisition means for acquiring a goal registered in a goal sharing service that receives registration of the goals from a plurality of users and shares an achievement status of each goal by each user among the users, and conformity determination means for determining conformability between the acquired goal and an evaluation criterion for evaluating a user who has registered or achieved the goal.

In a determination program according to a tenth aspect, in the ninth aspect, the conformity determination means determines conformability between the goal represented by a text and the evaluation criteria by using a classification model that classifies the goal represented by the text into the evaluation criteria that conform to the goal.

### Supplementary Note 3

Some or all the above-described example embodiments may be described as follows.

An information processing device causing at least one processor to execute: goal acquisition processing for acquiring a goal registered in a goal sharing service that receives registration of the goals from a plurality of users and shares an achievement status of each goal by each user among the users; and conformity determination processing for determining the conformability between the acquired goal and an evaluation criterion for evaluating a user who has registered or achieved the goal.

The information processing device may further include a memory, and the memory may store a determination program for causing the processor to execute the goal acquisition processing and the conformity determination processing. The determination program may be recorded in a non-transitory tangible computer-readable recording medium.

### REFERENCE SIGNS LIST

1 information processing device
11 goal acquisition unit (goal acquisition means)
12 conformity determination unit (conformity determination means)
2 information processing device
201 goal acquisition unit (goal acquisition means)
202 conformity determination unit (conformity determination means)
204 evaluation criterion selection unit (evaluation criteria selection means)
205 output control unit (output control means)
206 reception unit (reception means)
211 classification model

What is claimed is:

1. An information processing device comprising:
at least one memory storing instructions; and
at least one processor configured to execute the instructions to:
acquire a goal registered in a goal sharing service that receives registration of the goals from a plurality of users and shares an achievement status of each goal by each user among the users; and
determine conformability between the acquired goal and an evaluation criterion for evaluating a user who has registered or achieved the goal.

2. The information processing device according to claim 1,
wherein the at least one processor is further configured to execute the instructions to:
select an evaluation criterion to be used for evaluation of a target user to be evaluated among users of the goal sharing service, from among a plurality of the evaluation criteria set in advance, based on user-related information regarding the target user and a determination result of the conformability.

3. The information processing device according to claim 2,
wherein the at least one processor is further configured to execute the instructions to:
cause an output device to output an aggregated data obtained by aggregating the selected evaluation criterion with respect to a goal registered or achieved by the target user.

4. The information processing device according to claim 3,
wherein the at least one processor is further configured to execute the instructions to:
cause the output device to output the aggregated data generated for a goal registered or achieved by the target user in a plurality of different periods to be displayed in association with each other.

5. The information processing device according to claim 1,
wherein the at least one processor is further configured to execute the instructions to:
determine conformability between the goal represented by a text and the evaluation criterion by using a classification model that classifies the goal represented by the text into the evaluation criterion that conforms to the goal.

6. The information processing device according to claim 1,
wherein the at least one processor is further configured to execute the instructions to:
receive correction of the goal; and
determine conformability between a goal after correction and the evaluation criterion if the goal is corrected.

7. A determination method comprising:
by at least one processor,
acquiring a goal registered in a goal sharing service that receives registration of the goals from a plurality of users and shares an achievement status of each goal by each user among the users; and
determining conformability between the acquired goal and an evaluation criterion for evaluating a user who has registered or achieved the goal.

8. The determination method according to claim 7, further comprising:
by at least one processor,
determining conformability between the goal represented by text and the evaluation criterion using a classification model that classifies the goal represented by the text into the evaluation criterion that conforms with the goal.

9. A non-transitorily recording medium recording a program for causing a computer to execute the steps of:
acquiring a goal registered in a goal sharing service that receives registration of the goals from a plurality of users and shares an achievement status of each goal by each user among the users; and
determining conformability between the acquired goal and an evaluation criterion for evaluating a user who has registered or achieved the goal.

10. The non-transitorily recording medium according to claim 9, further storing a program causing the computer to execute processing comprising:
determining conformability between the goal represented by text and the evaluation criterion using a classification model that classifies the goal represented by the text into the evaluation criterion that conforms with the goal.
